(19) United States
(12) Patent Application Publication
(10) Pub. No.: US 2006/0174913 A1
(43) Pub. Date: Aug. 10, 2006

(54) Apparatus for and method of wet processing semiconductor substrates

(76) Inventors: Dong-hoon Jung, Hwaseong-si (KR); Jong-jae Lee, Suwon-si (KR); Seung-kun Lee, Suwon-si (KR); Man-young Lee, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/322,389

(22) Filed: Jan. 3, 2006

(30) Foreign Application Priority Data
Feb. 7, 2005 (KR) 10-2005-0011437

(51) Int. Cl. C23G 1/00; B08B 9/20; B08B 3/00

(52) U.S. Cl. 134/2; 134/25.4; 134/61; 134/155

(57) ABSTRACT

A wet processing apparatus includes a bath in which a plurality of semiconductor substrates are to be seated, and which bath has drain valves defining drain openings between a bottom wall and the lower portions of side walls of the bath. Each of the drain valves also includes a gate mounted on the lower portion of one of the side walls. The gates of the drain valves are movable to selectively open and close the drain openings. A plurality of substrates are transferred into the bath and are held under a body of liquid contained in a bath while the substrates are oriented vertically as disposed generally parallel to one another. In this state, the side walls of the baths face the peripheral edges of the substrates at both sides of the substrates. Thus, the substrates are prevented from moving toward and becoming stuck to one another when the liquid is drained from the bath.

### BACKGROUND OF THE INVENTION

1. Field of the Invention

The present invention relates to apparatus for fabricating a semiconductor device. More particularly, the present invention relates to wet processing for cleaning or etching a batch of semiconductor substrates.

2. Description of the Related Art

Semiconductor devices are fabricated, in general, by forming predetermined circuit patterns on a semiconductor substrate, such as a silicon substrate. More specifically, a circuit pattern is formed by subjecting the substrate to a plurality of processes including a deposition process for forming a thin film on the substrate, an ion implantation process, a thermal oxidation or annealing process, a photolithography process for forming a photoresist pattern corresponding to the desired circuit pattern over the thin film, and an etching process for etching the thin film using the photoresist pattern as a mask.

The etching process may be either a dry etching process or a wet etching process. A dry etching process uses an etching gas as an etchant whereas a wet etching process uses a chemical solution as an etchant. Accordingly, the wet etching process conventionally includes a bath that contains a chemical solution.

Also, the semiconductor substrate is usually cleaned prior to the deposition and annealing processes. Most of the cleaning processes used prior to the deposition and annealing processes are performed in a wet cleaning apparatus which contains a chemical solution. The cleaning process is thus performed through a chemical reaction initiated by the chemical solution. Also, the semiconductor substrate can be cleaned after it has been wet etched to remove chemical solution that remains on the semiconductor substrate after the wet etching process.

Accordingly, a wet etching apparatus may include separate wet etching, wet cleaning and rinsing baths. Therefore, the wet processing of semiconductor substrates involves guiding the substrates through one or more baths. A bath of a conventional wet etching apparatus will now be described with reference to FIG. 1.

The bath shown in FIG. 1 is a quick dump rinse (QDR) bath 100 for quick dump rinsing. The interior of the QDR bath 100 is delimited by side walls 110 and a bottom wall 105, and is filled with distilled water, for example. A plurality of semiconductor substrates 120 are seated on a guide 115 in the QDR bath 100.

The QDR bath 100 is used for removing chemicals from the semiconductor substrates 120. Accordingly, the QDR bath 100 can form a system together with an etching bath or a cleaning bath (not shown). That is, chemicals remaining on the semiconductor substrates 120 after a wet etch or cleaning process can be rinsed with distilled water by submerging the substrates in the distilled water in the QDR bath 100 and then quickly draining the distilled water from the QDR bath 100.

A drain valve 125 for draining the distilled water from the QDR bath 100 is located at the bottom of the QDR bath 100. Conventionally, the drain valve 125 is disposed at the central part of the inner surface of the bottom wall 105. Also, the inner surface of the bottom wall 105 of the QDR bath 100 can have a “V” shape to facilitate the quick draining of the distilled water. In this case, the drain valve 125 is mounted at the apex of the “V” which is the lowest point along the inner surface of the bottom wall 105. Accordingly, the distilled water filled in the QDR bath 100 is rapidly drained, as indicated by the arrows in FIG. 1, when the drain valve 125 is quickly opened.

As a result, the distilled water flows along surfaces of the semiconductor substrates 120 toward the drain valve 125 as the distilled water is drained from the QDR bath 100. Accordingly, the semiconductor substrates 120 stick to each other in an upper region A of the QDR bath 100 due to surface tension of the distilled water.

In this case, some of the chemicals are not removed from the substrates 120 because the distilled water cannot flow to areas where the semiconductor substrates 120 are stuck together. The chemicals remaining on the surfaces of the semiconductor substrates 120 can be the cause of a process failure that reduces the yield of the semiconductor device manufacturing process. Specifically, the chemicals may be a source of particle contamination or may cause undesired reactions during subsequent processes.

Furthermore, the diameter of conventional semiconductor substrates has increased from, for example, 200 mm to 300 mm in diameter. To accommodate these larger substrates, the guides now have relatively small gaps between their wafer slots and the QDR baths have become relatively large. Accordingly, the problems associated with the semiconductor substrates becoming stuck to each other due to the surface tension of the distilled water have become even more serious. Also, although such problems have been described above in connection QDR baths, these problems also exist in other types of wet process baths.

### SUMMARY OF THE INVENTION

An object of the present invention is to provide a wet processing apparatus having a bath in which substrates can be rinsed with high efficacy. Likewise, an object of the present invention is to provide a method of rinsing a batch of substrates with high efficacy.

Another object of the present invention is to provide a wet processing apparatus having a bath in which substrates will not become stuck to one another. Similarly, another object of the present invention is to provide a wet processing method in which a batch of substrates processed in a bath are prevented from becoming stuck to one another when liquid is drained from the bath.

According to an aspect of the present invention, there is provided a wet processing apparatus having a plurality of baths for wet processing a plurality of semiconductor substrates, wherein at least one of the baths has a drain valve defining an opening leading out of the bath at a location between the bottom wall of the bath and a lower portion of a respective one of the side walls of the bath. The drain valve also comprises a gate that is movable to selectively cover and uncover the drain opening. The gate of the drain valve is mounted on the lower portion of the side wall.

The bath can be a QDR bath for quick rinsing the substrates.

Preferably, the bath has a pair of drain valves. The drain valves define drain openings each of which is located between the bottom wall of the bath and the lower portion of a respective one of the side walls of the bath. The gates of the drain valves are mounted on the lower portions of the side walls, respectively. Each drain valve can be moved in a direction parallel to the semiconductor substrates in the bath to cover or uncover the drain opening.

According to another aspect of the present invention, there is provided a method of wet processing a plurality of substrates, comprising: holding the substrates under a body of liquid contained in a bath while the substrates are oriented vertically as disposed generally parallel to one another, and draining the liquid from the bath through at least one drain opening defined below the substrates between a bottom wall of the bath and a lower portion of a respective side wall of the bath.

The drain opening(s) extend alongside at least the entire region occupied by the substrates in the bath.

Also, the substrates may be transferred into the bath from an etching or cleaning bath containing chemicals. In this case, the liquid is distilled water for use in rinsing the substrates.

### BRIEF DESCRIPTION OF THE DRAWINGS

The above and other objects, features and advantages of the present invention will become more apparent from the following detailed description of the preferred embodiments thereof made with reference to the attached drawings in which:

FIG. 1 is a schematic side view of a bath of a conventional wet processing apparatus;

FIG. 2 is a schematic diagram of an embodiment of a wet processing apparatus according to the present invention;

FIG. 3 is a side view of a QDR bath of the apparatus of FIG. 2 when a drain valve of the QDR bath is closed;

FIG. 4 is a front view of the QDR bath of the apparatus of FIG. 2 when a drain valve of the QDR bath is closed;

FIG. 5 is a side view of the QDR bath of the apparatus of FIG. 2 when a drain valve of the QDR bath is opened; and

FIG. 6 is a front view of the QDR bath of the apparatus of FIG. 2 when a drain valve of the QDR bath is opened.

### DETAILED DESCRIPTION OF THE PREFERRED EMBODIMENTS

The present invention will now be described more fully with reference to FIGS. 2 through 6.

Referring first to FIG. 2, the wet processing apparatus 200 includes a first bath 300, a second bath 400, a drier 500, and a transfer system 600 for transporting semiconductor substrates 250. The transfer system 600 can be a robotic device, for example, that can transport a plurality of semiconductor substrates 250 at once. Accordingly, the semiconductor substrates 250 can be sequentially transferred from the first bath 300 to the second bath 400 and the drier 500 by the transfer system 600.

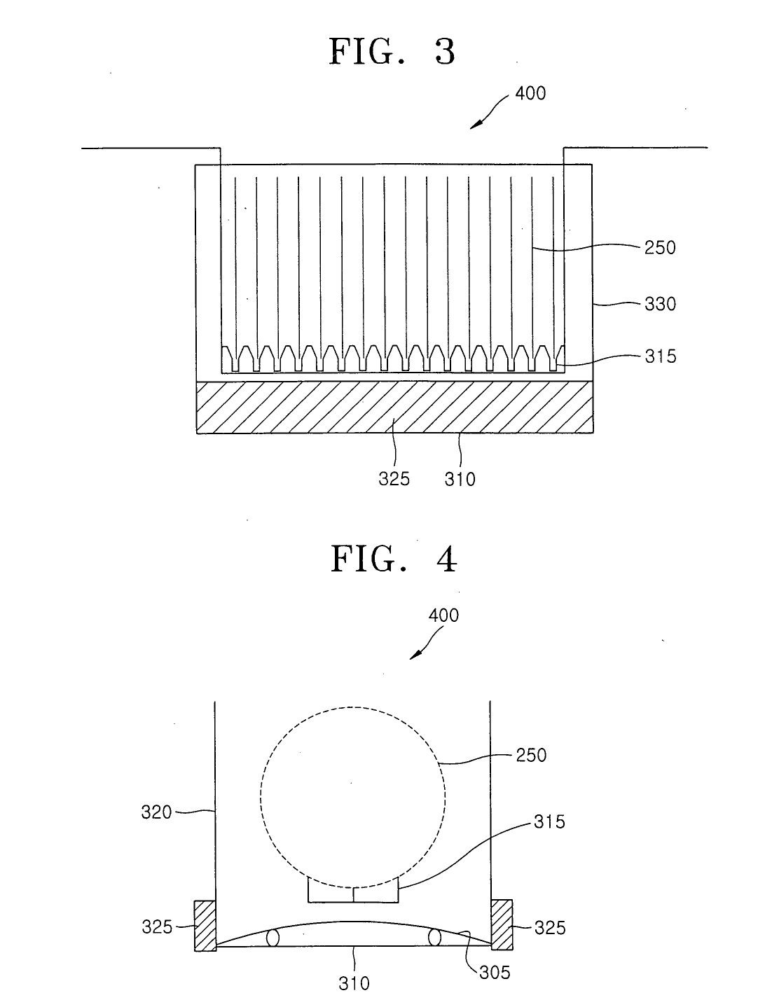

More specifically, the first bath 300 is a bath for chemically processing the semiconductor substrates 250. For example, the first bath 300 can be a cleaning bath or an etching bath. The drier 500 removes liquid, such as distilled water, remaining on a surface of the semiconductor substrates 250. The second bath 400 may be a QDR bath that rinses the chemically processed semiconductor substrates 250 using distilled water. The QDR bath 400 will now be described in detail with reference to FIGS. 3 through 6.

Referring to FIGS. 3 and 4, a plurality of semiconductor substrates 250 are seated on a guide 315 in the QDR bath 400. That is, the semiconductor substrates 250 are transferred from the first bath 300 to the QDR bath 400 by the transfer system 600. The QDR bath 400 includes side walls 320, front and rear end walls 330 that span the side walls 320 at opposite ends of the bath, a bottom wall having an interior surface 305 defining the bottom of the bath, and a pair of drain valves 325 operable to drain the distilled water from the QDR bath 400. The bottom wall of the QDR bath 400 may also have a flat bottom exterior surface 310. The QDR bath 400 is filled with liquid, such as distilled water. The drain valves 325 are closed in FIGS. 3 and 4.

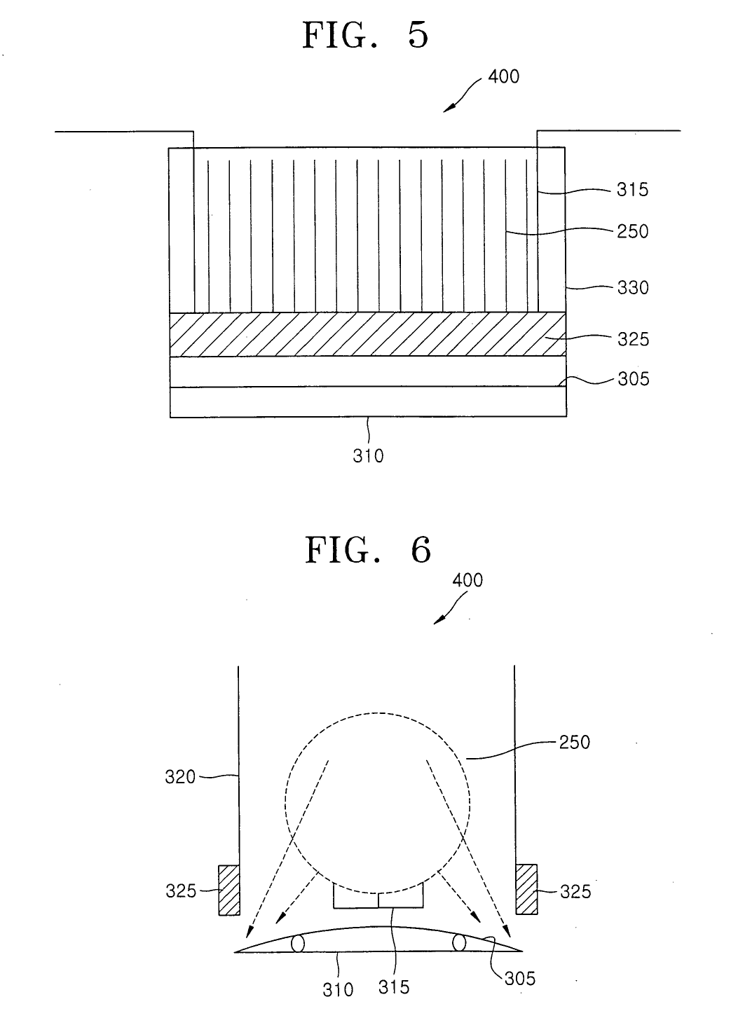

FIGS. 5 and 6 illustrate the QDR bath 400 when the drain valves 325 are open. Referring to FIG. 5, the drain valves 325 define drain openings that lead into the QDR bath 400 at lower side portions of the QDR bath 400, and comprise gates that are movable to cover and uncover the drain openings, respectively.

More particularly, the drain openings are located between the bottom wall and the side walls 320 of the bath so as to face both sides of the semiconductor substrates 250 seated in the QDR bath 400. Also, the drain openings extend alongside at least the entire region occupied by the substrates 250 when the substrates 250 are seated on the guide 315 in the bath 400, i.e., the drain openings are each at least as long as the guide 315. Here, the drain openings extend along the entire length of the side walls 320. The gates of the drain valves 325 are mounted on lower portions of the side walls 320 of the QDR bath 400, respectively. The gates of the drain valves 325 can be opened and closed over the drain openings in directions extending parallel to the directions in which the semiconductor substrates 250 are lowered into and withdrawn from the bath.

Accordingly, when the drain valves 325 are open, the distilled water is quickly drained from the QDR bath 400 through the drain openings at locations between the interior surface 305 of the bottom wall and the side walls 320. Therefore, the distilled water flows out of the QDR bath 400 at both sides of the semiconductor substrates 250. At this time, lower portions of the semiconductor substrates 250 are held by the guide 315. Thus, the distilled water hardly acts on upper portions of the semiconductor substrates 250 in a direction that will cause the upper portions of the substrates 250 to move towards each other.

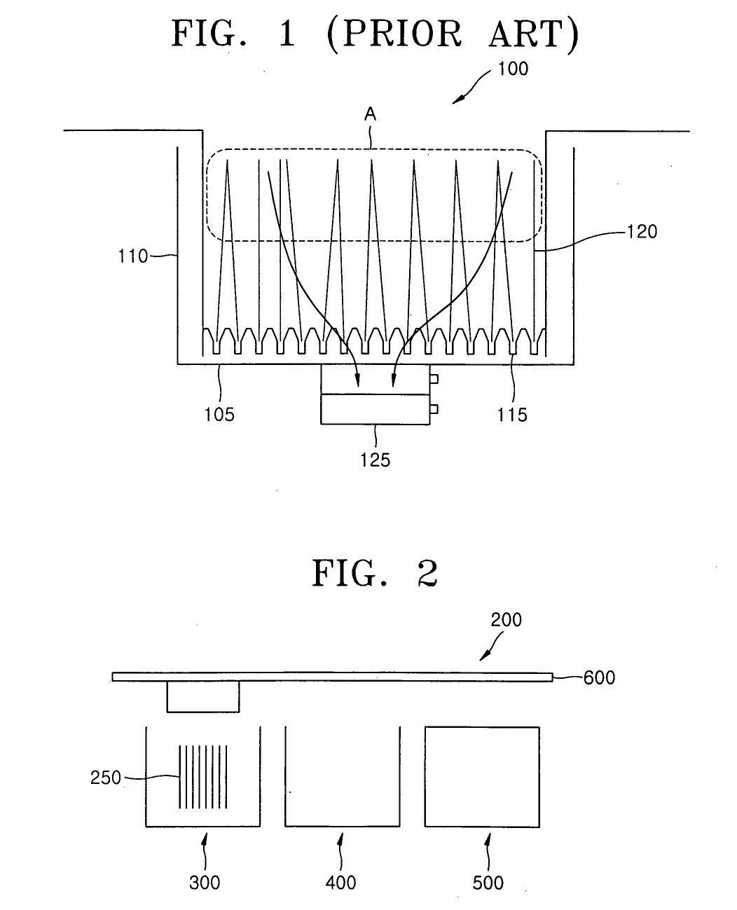

That is, in the conventional QDR bath 100 shown in FIG. 1, the distilled water flows from upper portions of the semiconductor substrates to a lower central portion of the bath 100. On the other hand, in the QDR bath 400 of the present invention, the distilled water flows along the semiconductor substrates 250 from upper portions of the semiconductor substrates 250 to lower side portions of the semiconductor substrates 250. Therefore, the upper portions of the semiconductor substrates 250 are less likely to be moved into contact with each other.

Therefore, there is less of a tendency of the upper portions of the semiconductor substrates 250 to stick together. Hence, the efficiency by which the semiconductor substrates 250 are rinsed is relatively high. A high rinse efficiency in the wet processing of semiconductor substrates can increase the yield of the semiconductor manufacturing process because a high rinse efficiency means fewer chemicals left on the substrates to contaminate the substrates or create undesirable reactions in subsequent processes.

Referring to FIG. 6, the interior surface 305 of the bottom wall of the QDR bath 400 may be inclined downwardly from the center of the bottom of the QDR bath 400 so that the distilled water is guided towards both side walls 320 when the drain valve 325 are opened. Accordingly, the distilled water is effectively guided towards the lower portions of the side walls 320 where the drain valves 325 are opened. Moreover, the interior surface 305 may curve smoothly upwardly from the sides to the center of the bottom of the QDR bath 400 to prevent eddies from being generated in the distilled water as the distilled water is drained from the QDR bath 400.

Finally, although the present invention has been particularly shown and described with reference to the preferred embodiments thereof, the present invention is not so limited. For example, although the present invention has been described in connection with a QDR bath, the present invention can also be applied to other types of baths. Therefore, various changes in form and details may be made to the present invention as described above without departing from the true spirit and scope thereof as defined by the following claims.

What is claimed is:

1. A wet processing apparatus for wet processing a plurality of semiconductor substrates, said apparatus comprising: a plurality of baths; and a transfer system that transfers a plurality of substrates into and out of the baths, wherein the substrates are oriented vertically as disposed generally parallel to each other when the substrates are disposed in at least one of the baths, wherein said at least one of the baths includes side walls that face the outer peripheral edges of the semiconductor substrates, at both sides of the substrates, respectively, when the substrates are disposed within the bath, end walls spanning the side walls at front and rear ends of the bath, respectively, a bottom wall, and at least one drain valve that allows liquid to be drained from the bath, each said drain valve defining an opening leading out of the bath at a location between the bottom wall and a lower portion of a respective one of the side walls, and each said drain valve comprising a gate that is movable to selectively cover and uncover the drain opening.

2. The apparatus of claim 1, wherein the bath is a QDR bath for quick dump rinsing.

3. The wet processing apparatus of claim 2, wherein said at least one drain valve comprises a pair of drain valves defining openings leading out of the bath at locations between the bottom wall and lower portions of the side walls, respectively.

4. The apparatus of claim 3, wherein the gates of the drain valves are mounted on lower portions of the side walls of the bath.

5. The apparatus of claim 1, wherein the gate of each said drain valve is opened and closed movable, to selectively cover and uncover the drain opening, in a direction parallel to the direction in which semiconductor substrates are transferred into and out of said at least one bath by the transfer system.

6. The apparatus of claim 1, wherein said at least one drain valve comprises a pair of drain valves defining openings leading out of the bath at locations between an interior surface of the bottom wall and lower portions of the side walls, respectively, and the interior surface of the bottom wall is inclined upwardly from the drain openings towards a central portion of the bottom of the bath.

7. The apparatus of claim 6, wherein the interior surface is a curved surface.

8. The apparatus of claim 7, wherein the bottom wall has a flat exterior bottom surface that intersects the curved interior surface at opposite sides of the bottom wall.

9. The apparatus of claim 1, further comprising a guide on which the semiconductor substrates are seated when the substrates are disposed in said at least one bath.

10. The apparatus of claim 9, wherein the drain opening extends alongside at least the entire region occupied by the semiconductor substrates when the substrates are seated on the guide in said at least one bath.

11. The apparatus of claim 1, wherein the drain opening extends along the entire length of said respective one of the side walls.

12. A method of wet processing a plurality of substrates, said method comprising:
transferring a plurality of substrates into a bath, and holding the substrates under a body of liquid contained in a bath while the substrates are oriented vertically as disposed generally parallel to one another;
with the substrates being held under the body of liquid in the bath as oriented vertically, draining the liquid from the bath through at least one drain opening, the drain opening being defined below the substrates between a bottom wall of the bath and a lower portion of a respective side wall of the bath that faces the outer peripheral edges of the substrates at one side of the substrates; and
subsequently removing the substrates from the bath.

13. The method of claim 12, wherein the drain opening extends alongside at least the entire region occupied by the substrates in the bath.

14. The method of claim 12, wherein the draining of the liquid comprises simultaneously draining the liquid through a pair of drain openings each defined between the bottom wall of the bath and a lower portion of a respective one of side walls of the bath that face the outer peripheral edges of the substrates at both sides of the substrates.

15. The method of claim 14, wherein the drain openings extend alongside at least the entire region occupied by the substrates in the bath.

16. The method of claim 12, wherein the substrates are held by having the substrates seated on a guide disposed in the bath.

17. The method of claim 12, wherein said transferring of the substrates comprises transferring the substrates from a first bath containing chemicals.

18. The method of claim 17, wherein the liquid is distilled water, and the draining of the liquid rinses the substrate.
